(19) United States
(12) Patent Application Publication
(10) Pub. No.: US 2022/0169023 A1
(43) Pub. Date: Jun. 2, 2022

(54) LIQUID EJECTING DEVICE

(71) Applicant: Seiko Epson Corporation, Tokyo (JP)

(72) Inventor: Daisuke HIRUMA, Matsumoto-shi (JP)

(21) Appl. No.: 17/536,945

(22) Filed: Nov. 29, 2021

(30) Foreign Application Priority Data
Nov. 30, 2020 (JP) 2020-198233

(51) Int. Cl. B41J 2/14; B41J 2/165

(52) U.S. Cl. CPC B41J 2/14; B41J 2/16523

(57) ABSTRACT

A liquid ejecting device includes a first tube including a first tip portion and that passes a waste liquid, a second tube including a second tip portion and that passes the waste liquid, a storage unit including an opening portion through which the first tip portion and the second tip portion are inserted, and that stores the waste liquid, and a guide that guides the first tip portion and the second tip portion to the opening portion. The guide includes an enclosing unit enclosing the first tip portion and the second tip portion, the enclosing unit includes a first member and a second member sandwiching the first tip portion and the second tip portion, a first holding member extending from the first member, and a second holding member extending from the second member. The first holding member and the second holding member are disposed offset from each other in a staggered manner.

The present application is based on, and claims priority from JP Application Serial Number 2020-198233, filed Nov. 30, 2020, the disclosure of which is hereby incorporated by reference herein in its entirety.

### BACKGROUND

### 1. Technical Field

The present disclosure relates to a liquid ejecting device, for example.

### 2. Related Art

JP-A-2020-11434 describes a liquid ejecting device including an ejecting unit configured to eject a liquid, a maintenance device, which is an example of an accommodating unit, for receiving the liquid ejected by the ejecting unit as a waste liquid, a tube through which the waste liquid received by the maintenance device flows, and an accommodating body, which is an example of a storage unit, including an opening portion through which a tip of the tube is inserted. This liquid ejecting device includes a tube guide, which is an example of a guide, to which the tube is attached. The tube guide, with the tube being attached, is configured to guide the tube to the opening portion of the accommodating body.

The tube guide includes an enclosing unit configured to enclose the tube. The tube is enclosed by the enclosing unit by, for example, being inserted into the enclosing unit. As a result, the tube is attached to the guide and guided to the opening portion.

In the liquid ejecting device, a plurality of tubes may be provided, and waste liquid flowing through each tube may be stored in a single storage unit. In this case, the plurality of tubes are attached to a single guide, and thus guided to the opening portion of the storage unit. When the plurality of tubes are attached to the guide, the tubes may rub against one another. For example, when a second tube is inserted into the enclosing unit along a first tube, the second tube is attached to the guide to which the first tube is attached while the tubes rub against each other. This may damage the tubes.

### SUMMARY

A liquid ejecting device for solving the above-described problems includes an ejecting unit configured to eject a liquid onto a medium, at least one accommodating unit configured to receive the liquid ejected from the ejecting unit as a waste liquid, a first tube including a first tip portion that is a portion including a tip and configured to pass the waste liquid received by the accommodating unit, a second tube including a second tip portion that is a portion including a tip and configured to pass the waste liquid received by the accommodating unit, a storage unit including an opening portion through which the first tip portion and the second tip portion are inserted, and configured to store the waste liquid, and a guide to which the first tube and the second tube are attached, and configured to guide the first tip portion and the second tip portion to the opening portion. The guide includes an enclosing unit configured to enclose the first tip portion and the second tip portion. The enclosing unit includes a first member and a second member that face each other and sandwich the first tip portion and the second tip portion, a first holding member extending from the first member so as to approach the second member, and a second holding member extending from the second member so as to approach the first member. The first holding member and the second holding member are disposed offset from each other in a staggered manner.

### BRIEF DESCRIPTION OF THE DRAWINGS

FIG. 1 is a front view illustrating an exemplary embodiment of a liquid ejecting device.

FIG. 2 is a side view of a holding unit.

FIG. 3 is a plan view of the holding unit.

FIG. 4 is a perspective view of a guide.

FIG. 5 is a front view of the guide.

FIG. 6 is a plan view of the guide.

FIG. 7 is a bottom view of the guide as viewed from a side opposite to that of FIG. 6.

FIG. 8 is a side view of the guide.

FIG. 9 is a side view of the guide as viewed from a side opposite to that of FIG. 8.

FIG. 10 is a rear view of the guide as viewed from a side opposite to that of FIG. 5.

FIG. 11 is a perspective view of an enclosing unit.

FIG. 12 is a plan view of the enclosing unit.

FIG. 13 is a front view of the enclosing unit.

### DESCRIPTION OF EXEMPLARY EMBODIMENTS

An exemplary embodiment of a liquid ejecting device will be described below with reference to the drawings. The liquid ejecting device is, for example, an ink jet-type printer that records an image such as characters and photographs by ejecting ink, which is an example of a liquid, onto a sheet, which is an example of a medium.

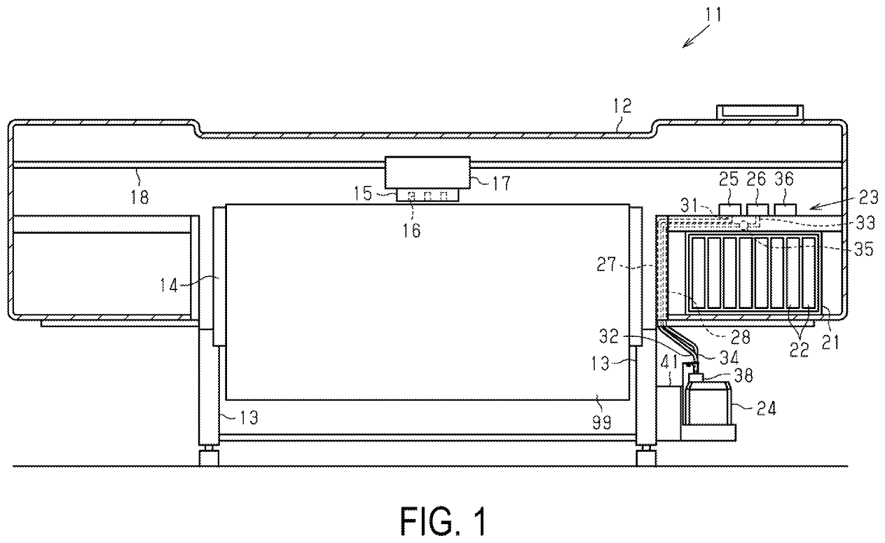

As illustrated in FIG. 1, a liquid ejecting device 11 includes, for example, a housing 12 and leg portions 13. The housing 12 is supported by the leg portions 13. The housing 12 accommodates various configurations in which the liquid ejecting device 11 is provided. The leg portions 13 are provided extending from the housing 12.

The liquid ejecting device 11 includes, for example, a support 14. The support 14 is provided, for example, across an inside and an outside of the housing 12. The support 14 supports, for example, a medium 99 to be transported.

The liquid ejecting device 11 includes an ejecting unit 15. The ejecting unit 15 is provided, for example, in the housing 12. The ejecting unit 15 includes one or a plurality of nozzles 16. Further, the ejecting unit 15 includes a nozzle surface (not illustrated) provided with the one or plurality of nozzles 16. The ejecting unit 15 ejects liquid from the nozzle 16 onto the medium 99. The ejecting unit 15 is a so-called head. Thus, an image is recorded onto the medium 99. The ejecting unit 15 ejects the liquid onto the medium 99 supported by the support 14, for example.

The liquid ejecting device 11 includes a carriage 17, for example. The carriage 17 mounts the ejecting unit 15. The carriage 17 scans the medium 99. Thus, the liquid ejecting device 11 is a serial-type printer, but may be a line-type printer that ejects liquid across a width of the medium 99 all at once.

The liquid ejecting device 11 includes a guide member 18, for example. The guide member 18 is provided, for example, in the housing 12. The guide member 18 is an elongated member extending across a width of the housing 12. The guide member 18 may be sheet metal or may be a rod. The guide member 18 is fixed to the housing 12. The guide member 18 guides the carriage 17 and supports the carriage 17. The carriage 17 moves along the guide member 18, scanning the medium 99.

The liquid ejecting device 11 includes a mounting portion 21, for example. The mounting portion 21 is provided, for example, in the housing 12. The mounting portion 21 is configured to be capable of mounting one or a plurality of accommodating bodies 22 that accommodate liquid. The accommodating body 22 accommodates liquid supplied to the ejecting unit 15. Accordingly, the liquid accommodated in the accommodating body 22 is supplied to the ejecting unit 15. The accommodating body 22 is, for example, an ink cartridge. The accommodating body 22 may be mounted onto the carriage 17.

The liquid ejecting device 11 includes a maintenance mechanism 23 and a storage unit 24 that stores waste liquid received by the maintenance mechanism 23. The maintenance mechanism 23 is a mechanism for maintaining the ejecting unit 15. The maintenance mechanism 23 includes one or a plurality of accommodating units that receive liquid ejected by the ejecting unit 15 as waste liquid. The maintenance mechanism 23 includes, for example, a first accommodating unit 25 and a second accommodating unit 26 as the accommodating units.

The first accommodating unit 25 is a flushing box, for example. In the liquid ejecting device 11, so-called flushing in which the ejecting unit 15 ejects liquid is executed as appropriate to suppress clogging of the nozzle 16. The first accommodating unit 25 receives, as waste liquid, liquid ejected from the ejecting unit 15 by flushing. When flushing is executed, the ejecting unit 15 moves along the guide member 18 toward a position facing the first accommodating unit 25.

The second accommodating unit 26 is a cap, for example. The cap includes a lip portion provided with a recessed portion including an edge. In this case, the second accommodating unit 26 can execute so-called capping in which the lip portion comes into contact with the nozzle surface of the ejecting unit 15, thereby forming a space by the nozzle surface and the recessed portion. In the liquid ejecting device 11, cleaning in which liquid, bubbles, and the like that have thickened or solidified in the ejecting unit 15 are forcibly emitted from the nozzles 16 is executed as appropriate. The second accommodating unit 26 may receive liquid ejected from the ejecting unit 15 as waste liquid by cleaning in a state of capping, for example. The cleaning is, for example, pressurized cleaning in which liquid is emitted by pressurizing an interior of the ejecting unit 15, or suction cleaning in which liquid is emitted by suctioning the ejecting unit 15. When cleaning is executed, the ejecting unit 15 moves along the guide member 18 toward a position facing the second accommodating unit 26. Note that, in the liquid ejecting device 11, cleaning in which liquid, bubbles, and the like that have thickened or solidified in the ejecting unit 15 are forcibly emitted from the nozzle 16 may be executed in a state of capping, for example.

The maintenance mechanism 23 includes a plurality of tubes. The plurality of tubes are coupled to the accommodating unit. The plurality of tubes extend from the inside of the housing 12 toward the outside of housing 12, for example. The maintenance mechanism 23 includes, for example, a first tube 27 and a second tube 28 as the plurality of tubes.

The first tube 27 is a tube through which the waste liquid received by the first accommodating unit 25 flows. The first tube 27 is coupled to the first accommodating unit 25, for example. In this example, the first tube 27 is directly coupled to the first accommodating unit 25, for example. Note that the first tube 27 may be coupled to the first accommodating unit 25 via another configuration.

The first tube 27 includes a first base end portion 31, which is a base end portion, and a first tip portion 32, which is a tip portion. The first base end portion 31 is a portion coupled to the first accommodating unit 25, for example, and is a portion that includes a base end of the first tube 27. The first tip portion 32 is a portion facing the first base end portion 31 and is a portion that includes a tip of the first tube 27. The first tip portion 32 is inserted into the storage unit 24. The waste liquid flowing through the first tube 27 flows from the first base end portion 31 toward the first tip portion 32.

The second tube 28 is a tube through which the waste liquid received by the second accommodating unit 26 flows. The second tube 28 is coupled to the second accommodating unit 26, for example. The second tube 28 is directly coupled to the second accommodating unit 26, for example, but may be coupled to the second accommodating unit 26 via another configuration.

The second tube 28 includes a second base end portion 33, which is a base end portion, and a second tip portion 34, which is a tip portion. The second base end portion 33 is a portion coupled to the second accommodating unit 26, for example, and is a portion that includes a base end of the second tube 28. The second tip portion 34 is a portion facing the second base end portion 33 and is a portion that includes a tip of the second tube 28. The second tip portion 34 is inserted into the storage unit 24. The waste liquid flowing through the second tube 28 flows from the second base end portion 33 toward the second tip portion 33.

The first tube 27 and the second tube 28 are each coupled to separate accommodating units, but may be coupled to the same accommodating unit. That is, a plurality of tubes may be coupled to one accommodating unit. The first tube 27 and the second tube 28 are flexible, for example.

The maintenance mechanism 23 may include a pump 35. The pump 35 is provided, for example, in the second tube 28. The pump 35 suctions the waste liquid received by the second accommodating unit 26. When the pump 35 is driven in a state in which the second accommodating unit 26 caps the ejecting unit 15, suction cleaning in which liquid is forcibly emitted from the ejecting unit 15 is executed.

The maintenance mechanism 23 may include a wiping unit 36. The wiping unit 36 is, for example, a wiper such as a cloth or a rubber blade. In the ejecting unit 15, liquid is ejected and thus the liquid may adhere to the ejecting unit 15 itself. Therefore, the wiping unit 36 comes into contact with the ejecting unit 15, thereby wiping a mist of the liquid that adheres to the ejecting unit 15.

The storage unit 24 is positioned outside the housing 12. In this example, one or a plurality of storage units 24 are provided. The storage unit 24 is, for example, a waste liquid tank. The storage unit 24 includes an opening portion 38 into which tubes are inserted. The first tube 27 and the second tube 28 are inserted into the opening portion 38 of one storage unit 24. Specifically, the first tip portion 32 and the second tip portion 34 are inserted into the opening portion 38. The waste liquid flowing through the first tube 27 and the waste liquid flowing through the second tube 28 flow from the tip of the first tube 27 and the tip of the second tube 28 and are introduced into the storage unit 24 through the opening portion 38. In a case in which a plurality of the storage units 24 are provided, a tube separate from the first tube 27 and the second tube 28 is inserted into a storage unit separate from the storage unit 24 illustrated in FIG. 1.

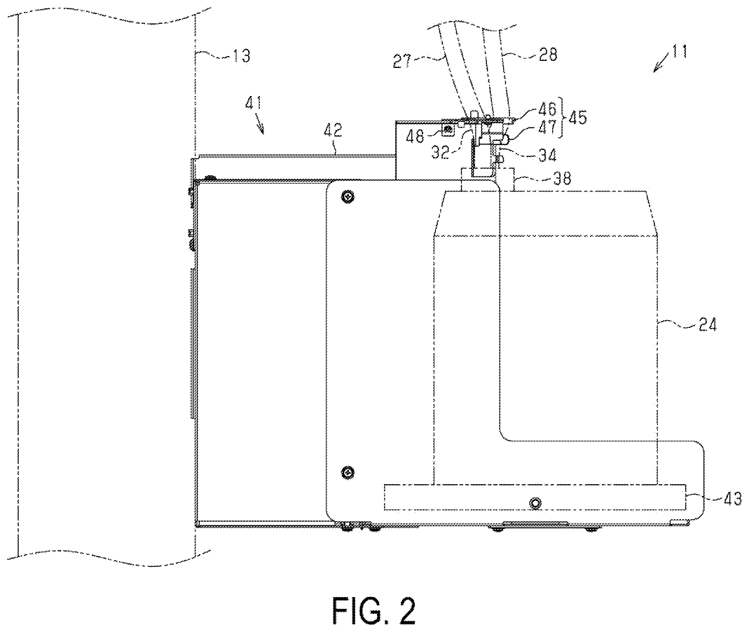

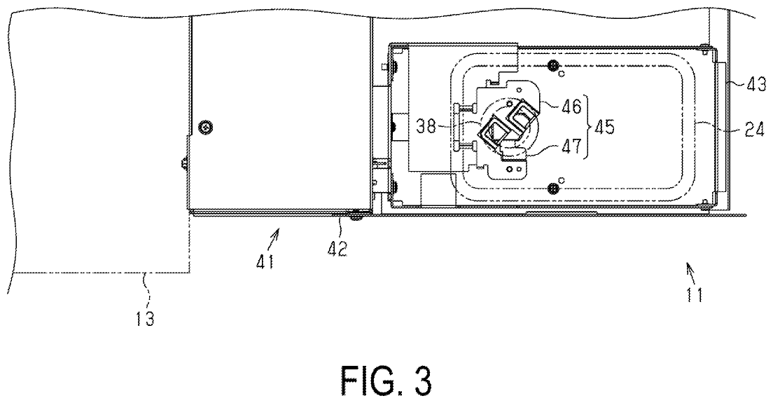

As illustrated in FIG. 2 and FIG. 3, the liquid ejecting device 11 includes a holding unit 41. The holding unit 41 is provided outside of the housing 12 and is attached to the leg portion 13, for example. The holding unit 41 is configured to hold the storage unit 24. The holding unit 41 includes a main body portion 42 and a tray 43, for example.

The main body portion 42 is attached to the leg portion 13, for example. The main body portion 42 is constituted by sheet metal, for example.

The tray 43 is attached to the main body portion 42. The tray 43 is configured to slide relative to the main body portion 42. The tray 43 is movable in the direction in which the carriage 17 scans, for example. As a result, the tray 43 is capable of being pulled out of the main body portion 42. The tray 43 is pulled out of the main body portion 42, thereby popping out from the main body portion 42. In FIG. 2 and FIG. 3, the tray 43 is in state of being pressed into the main body portion 42, that is, in a state of not being pulled out of the main body portion 42.

The storage unit 24 is mounted on the tray 43. The tray 43 is pulled out of the main body portion 42, thereby facilitating removal of the storage unit 24 from the holding unit 41. Thus, in a case in which the storage unit 24 is to be replaced, for example, the tray 43 is pulled out of the main body portion 42. With the tray 43 pressed into the main body portion 42, the holding unit 41 holds the storage unit 24. The tray 43 is provided in a quantity equivalent to the quantity of storage units 24, for example.

The liquid ejecting device 11 includes a guide 45. The first tube 27 and the second tube 28 are attached to the guide 45. The guide 45 is configured to guide the first tube 27 and the second tube 28 to the storage unit 24 held by the holding unit 41. Specifically, the guide 45 guides the first tip portion 32 and the second tip portion 34 into the opening portion 38 with the tray 43 pressed into the main body portion 42. Therefore, the guide 45 is provided at a position corresponding to the opening portion 38 of the storage unit 24 with the tray 43 pressed into the main body portion 42. The guide 45 includes, for example, an attachment unit 46 and an enclosing unit 47.

The attachment unit 46 is attached to the holding unit 41. The attachment unit 46 is constituted by sheet metal, for example. The attachment unit 46 is, for example, positioned directly above the opening portion 38 with the tray 43 pressed into the main body portion 42.

The attachment unit 46 includes a rotary shaft 48. The attachment unit 46 is attached to the main body portion 42 via the rotary shaft 48. The attachment unit 46 is rotatable about the rotary shaft 48. Thus, the guide 45 is rotatable relative to the main body portion 42.

When the tray 43 is pulled out of the main body portion 42, the first tube 27 and the second tube 28 inserted into the opening portion 38 move as the storage unit 24 moves. At this time, as the first tube 27 and the second tube 28 move, the guide 45 rotates about the rotary shaft 48. The tray 43 is pulled out of the body portion 42, thereby rotating the guide 45 in a counterclockwise direction in FIG. 2. This allows the tray 43 to move smoothly without resistance by the first tube 27 and the second tube 28 inserted into the opening portion 38.

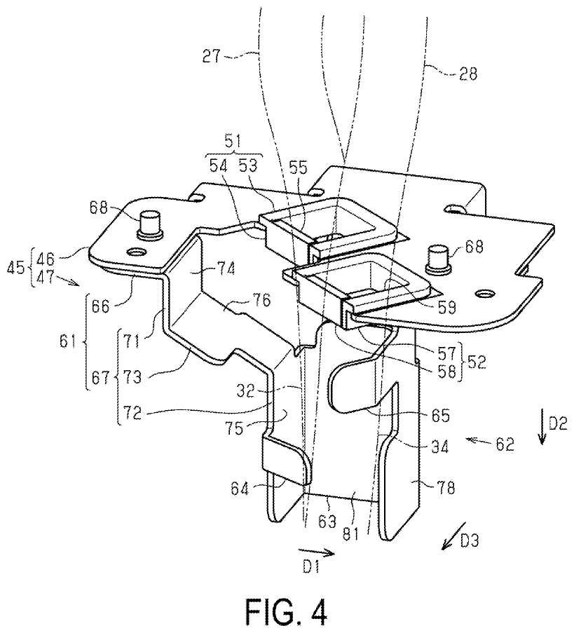

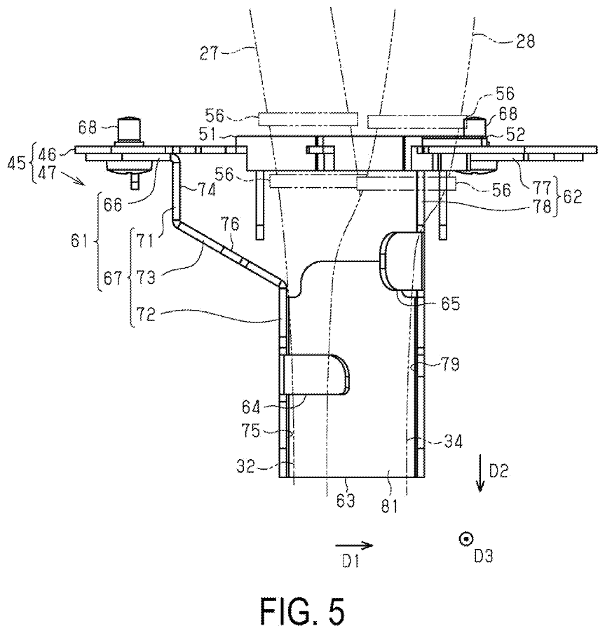

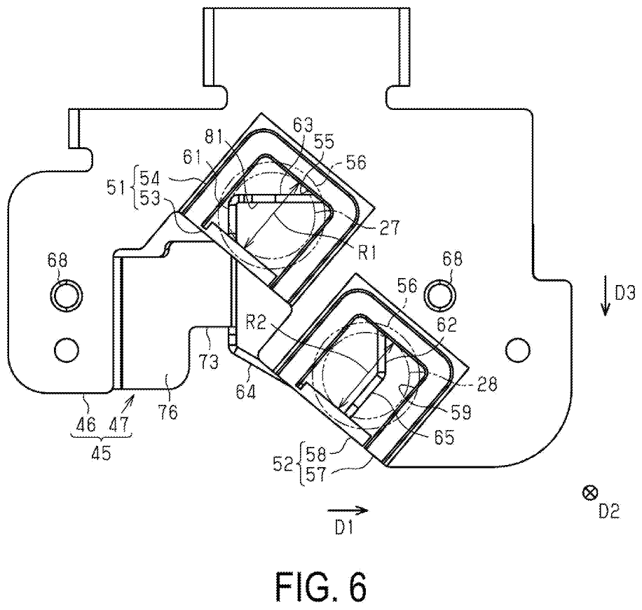

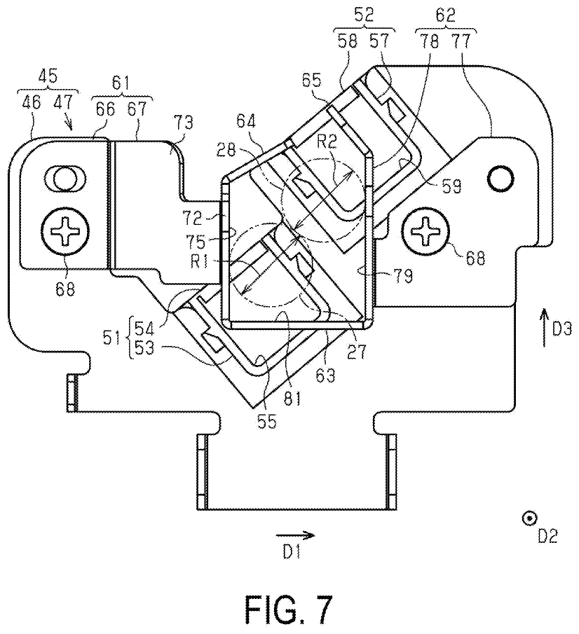

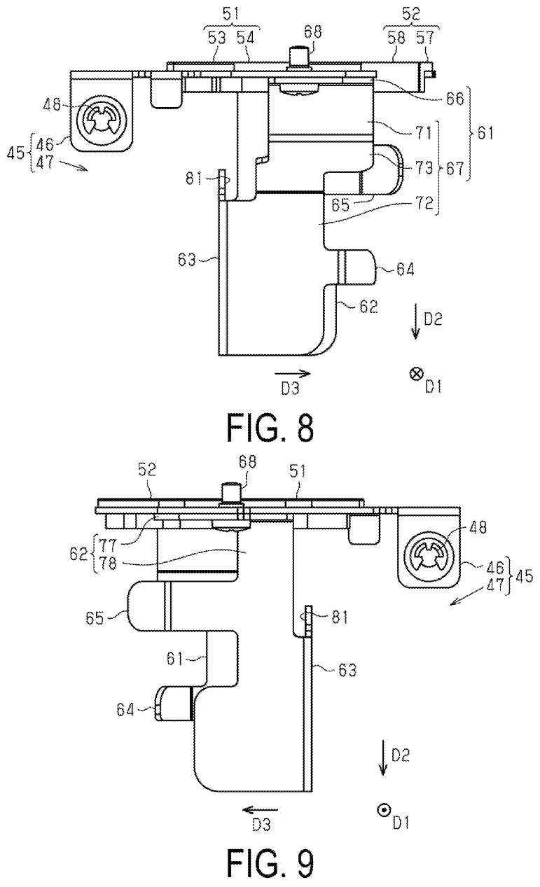

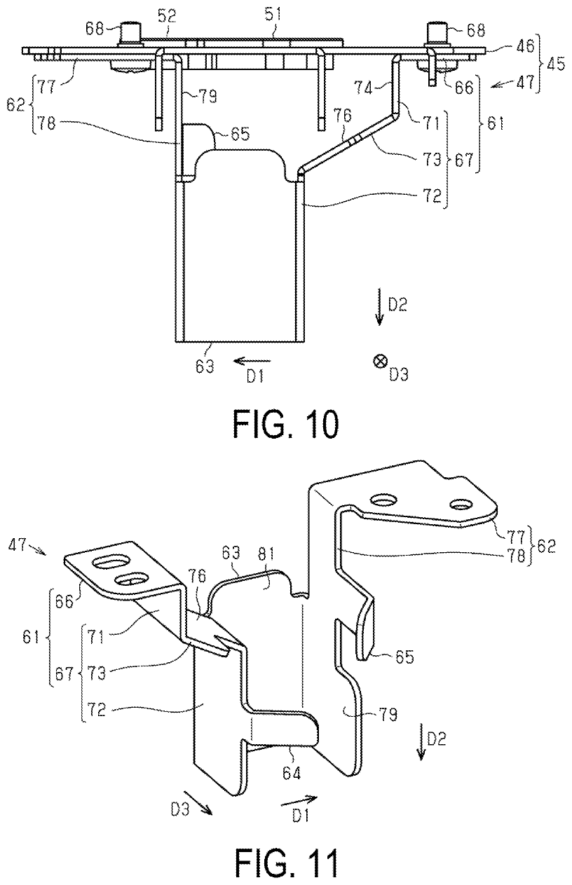

As illustrated in FIG. 4, FIG. 5, FIG. 6, FIG. 7, FIG. 8, FIG. 9, and FIG. 10, the attachment unit 46 includes a first clamp 51 and a second clamp 52. The first clamp 51 is a clamp configured to hold the first tube 27. The first clamp 51 is provided so as to surround four sides of the first tip portion 32, that is, enclose the first tip portion 32, when the guide 45 is viewed in plan view. The second clamp 52 is a clamp configured to hold the second tube 28. The second clamp 52 is provided so as to surround four sides of the second tip portion 34, that is, enclose the second tip portion 34, when the guide 45 is viewed in plan view.

The first clamp 51 includes a first holder 53 and a first lever 54. When the guide 45 is viewed in plan view from a direction of gravity, that is, a height direction of the liquid ejecting device 11, a shape of the first holder 53 is, for example, a U-shape. That is, an opening is provided in a portion of the first holder 53. Thus, the first holder 53 is provided so as to surround three sides of the first tip portion 32. The first lever 54 is attached to the first holder 53 and opens and closes relative to the first holder 53. The first lever 54 illustrated in FIG. 4 to FIG. 10 is closed relative to the first holder 53. At this time, the first lever 54 is positioned blocking the opening of the first holder 53. The first lever 54 is opened relative to the first holder 53, making it possible to attach the first tip portion 32 to the first holder 53. When the first lever 54 is closed relative to the first holder 53 with the first tip portion 32 attached to the first holder 53, the first tube 27 is held in the first clamp 51.

The first clamp 51 includes a first passage opening 55 through which the first tube 27 passes. The first passage opening 55 is constituted by the first holder 53 and the first lever 54. The first lever 54 is closed relative to the first holder 53, thereby forming the first passage opening 55. The size of the first passage opening 55 is a size that allows the first tube 27 to pass therethrough. In this example, a diameter of the first tube 27 is indicated as a first diameter R1.

A stopper 56 may be provided on the first tube 27. The stopper 56 is, for example, a binding strap. The stopper 56 is provided at two locations of the first tip portion 32, spaced apart. The first clamp 51 holds the area of the first tip portion 32 between the two locations where the stoppers 46 are provided. That is, between the two locations of the first tip portion 32 where the stoppers 56 are provided, the first tip portion 32 is passed through the first passage opening 55. The stopper 56 comes into contact with the first clamp 51, thereby suppressing a position shift of the first tube 27 relative to the first clamp 51. The stopper 56 may be provided before the first tube 27 is attached to the first clamp 51 or may be provided after the first tube 27 is attached to the first clamp 51.

The second clamp 52, similar to the first clamp 51, includes a second holder 57 and a second lever 58. The second holder 57 has a configuration similar to that of the first holder 53. The second lever 58 has a configuration similar to that of the first lever 54. The second clamp 52 includes a second passage opening 59 through which the second tube 28 passes. The second tube 28 may be provided with the stopper 56 similar to that of the first tube 27. The size of the second passage opening 59 is a size that allows the second tube 28 to pass therethrough. In this example, a diameter of the second tube 28 is indicated as a second diameter R2. In this example, the second diameter R2 is the same as the first diameter R1, but may be different.

The enclosing unit 47 is attached to the attachment unit 46. The enclosing unit 47 is constituted by sheet metal, for example. The enclosing unit 47 encloses the first tip portion 32 and the second tip portion 34. Specifically, the enclosing unit 47 encloses the first tip portion 32 and the second tip portion 34 at portions downstream of portions enclosed by the first clamp 51 and the second clamp 52 in a flow direction in which the waste liquid flows. That is, the enclosing unit 47 encloses a portion of the first tip portion 32 closer to the tip than the portion enclosed by the first clamp 51. The enclosing unit 47 encloses a portion of the second tip portion 34 closer to the tip than the portion enclosed by the second clamp 52. Expressed in another way, the first clamp 51 encloses a portion of the first tip portion 32 closer to a base end than the portion enclosed by the enclosing unit 47. The second clamp 52 encloses a portion of the second tip portion 34 closer to the base end than a portion enclosed by the enclosing unit 47.

The enclosing unit 47 encloses the first tip portion 32 and the second tip portion 34, thereby bundling the first tip portion 32 and the second tip portion 34. A portion of the enclosing unit 47 is inserted into the opening portion 38. The first tip portion 32 and the second tip portion 34 are inserted into the opening portion 38 by the enclosing unit 47 being inserted into the opening portion 38 with the first tip portion 32 and the second tip portion 34 in the bundled state.

The enclosing unit 47 includes a first member 61 and a second member 62. The enclosing unit 47 may include a third member 63. The enclosing unit 47 includes a first holding member 64 and a second holding member 65.

The first member 61 and the second member 62 are members that face each other. The first member 61 and the second member 62 sandwich the first tip portion and the second tip portion 34. Expressed in another way, the first tip portion 32 and the second tip portion 34 are positioned between the first member 61 and the second member 62.

The first member 61 is, for example, a member attached to the attachment unit 46 and extending from the attachment unit 46. The first member 61 includes a first attachment portion 66 and a first enclosing portion 67, for example.

The first attachment portion 66 is a portion attached to the attachment unit 46. The first attachment portion 66 is attached to the attachment unit 46 by, for example, a screw 68.

The first enclosing portion 67 is a portion that contributes to the enclosing of the first tip portion 32 and the second tip portion 34. The first enclosing portion 67 includes a first portion 71, a second portion 72, and a third portion 73, for example.

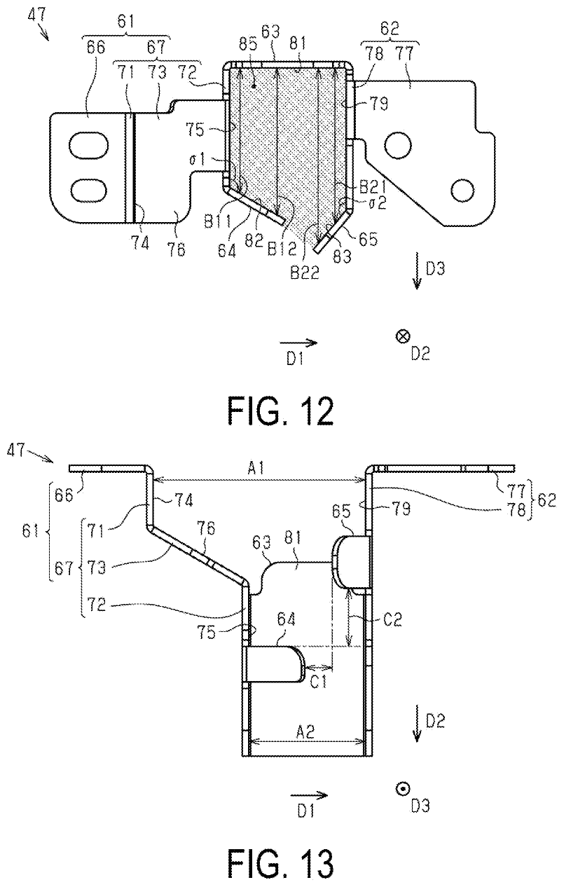

As illustrated in FIG. 11, FIG. 12, and FIG. 13, the first portion 71 is a portion coupled to the first attachment portion 66 and the third portion 73. The first portion 71 extends, bending from the first attachment portion 66. The first portion 71 includes a first surface 74 facing the second member 62. The first surface 74 is a surface facing inward in the enclosing unit 47. In other words, the first surface 74 is a surface facing at least one of the first tip portion 32 and the second tip portion 34 enclosed by the enclosing unit 47. Note that “enclosed by the enclosing unit 47” refers to a state in which the first tube 27 and the second tube 28 are attached to the guide 45.

A distance between the first portion 71 and the second member 62 is a first distance A1. The first distance A1 indicates a distance of an axial line perpendicular to the first surface 74. In this example, for example, a direction along the axial line perpendicular to the first surface 74 and from the first member 61 toward the second member 62 is referred to as a first direction D1. Therefore, the first distance A1 is the distance between the first portion 71 and the second member 62 in the first direction D1. The direction along the axial line perpendicular to the first surface 74 and from the second member 62 toward the first member 61 may be the first direction D1. The first direction D1 can also be described as a direction in which the first member 61 and the second member 62 face each other.

In this example, two directions different from the first direction D1 are referred to as a second direction D2 and a third direction D3. The second direction D2 and the third direction D3 are directions that represent a spread of the first surface 74. That is, the first surface 74 is a surface having a spread in the second direction D2 and the third direction D3.

The second portion 72 is a portion coupled to the third portion 73. The second portion 72 extends, bending from the third portion 73. The second portion 72 extends parallel to the first portion 71, for example. The second portion 72 includes a second surface 75 facing the second member 62. The second surface 75 is a surface facing inward in the enclosing unit 47. In other words, the second surface 75 is a surface facing at least one of the first tip portion 32 and the second tip portion 34 enclosed by the enclosing unit 47. The second surface 75 is parallel to the first surface 74, for example. Similar to the first surface 74, the second surface 75 is a surface having a spread in the second direction D2 and the third direction D3.

A distance between the second portion 72 and the second member 62 is a second distance A2. The second distance A2 is the distance between the second portion 72 and the second member 62 in the first direction D1. The second distance A2 is less than the first distance A1. That is, the second portion 72 is positioned in a position closer to the second member 62 than the first portion 71. The second distance A2 is greater than the first diameter R1 and the second diameter R2.

The second portion 72 faces the first tip portion 32 and the second tip portion 34. Specifically, the second portion 72 faces portions of the first tip portion 32 and the second tip portion 34 downstream, in the flow direction of the waste liquid, of the portions facing the first portion 71. That is, the second portion 72 faces portions of the first tip portion 32 and the second tip portion 34 closer to the tips than the portions faced by the first portion 71. In other words, the second portion 72 faces portions of the first tip portion 32 and the second tip portion 34 closer to the tips than the portions facing the first portion 71.

The third portion 73 is a portion coupled to the first portion 71 and the second portion 72. In this example, the first portion 71, the second portion 72, and the third portion 73 are formed by bending sheet metal. The third portion 73 is inclined relative to the first portion 71 and the second portion 72. That is, the first member 61 extends so that a distance between the first member 61 and the second member 62 changes from the first distance A1 to the second distance A2 by the third portion 73. The third portion 73 includes a third surface 76 inclined with respect to the first portion 71 and the second portion 72. The third surface 76 is a surface facing inward in the enclosing unit 47. In other words, the third surface 76 is a surface facing at least one of the first tip portion 32 and the second tip portion 34 enclosed by the enclosing unit 47. The third surface 76 is a surface continuous with the first surface 74 and the second surface 75.

As illustrated in FIG. 4, FIG. 5, FIG. 6, FIG. 7, FIG. 8, FIG. 9, and FIG. 10, the second member 62 is a member attached to and extending from the attachment unit 46, for example. The second member 62 includes a second attachment portion 77 and a second enclosing portion 78, for example.

The second attachment portion 77 is a portion attached to the attachment unit 46. The second attachment portion 77 is attached to the attachment unit 46 by, for example, the screw 68.

The second enclosing portion 78 is a portion that contributes to the enclosing of the first tube 27 and the second tube 28. The second enclosing portion 78 extends parallel to the first portion 71 and the second portion 72, for example. The second enclosing portion 78 includes an opposing surface 79. The opposing surface 79 is a surface facing inward in the enclosing unit 47. In other words, the opposing surface 79 is a surface facing at least one of the first tip portion 32 and the second tip portion 34 enclosed by the enclosing unit 47. The opposing surface 79 is, for example, a surface parallel to the first surface 74 and the second surface 75, and facing the first surface 74 and the second surface 75. Therefore, the opposing surface 79 is a surface having a spread in the second direction D2 and the third direction D3. An axial line perpendicular to the first surface 74 is also an axial perpendicular to the opposing surface 79.

The third member 63 is coupled to the first member 61 and the second member 62. Specifically, the third member 63 is coupled to the second portion 72 and the second member 62 of the first member 61. The third member 63 includes an inner surface 81. The inner surface 81 is a surface facing inward in the enclosing unit 47. In other words, the inner surface 81 is a surface facing at least one of the first tip portion 32 and the second tip portion 34 enclosed by the enclosing unit 47. The inner surface 81 is a surface facing the third direction D3. The third direction D3 is a direction along an axial line perpendicular to the inner surface 81, from the inner surface 81 toward the inside of the enclosing unit 47, for example. The inner surface 81 has a spread in the first direction D1 and the second direction D2. The inner surface 81 is, for example, a surface perpendicular to the first surface 74, the second surface 75, the third surface 76, and the opposing surface 79. The inner surface 81 is continuous with the second surface 75 and the opposing surface 79, for example.

The first holding member 64 is a member configured to hold at least one of the first tube 27 and the second tube 28 with the inner surface 81 in a state in which the first tube 27 and the second tube 28 are attached to the guide 45. The holding member 64 is a member that comes into contact with at least one of the first tube 27 and the second tube 28, thereby suppressing the falling of the first tube 27 and the second tube 28 out of the enclosing unit 47.

As illustrated in FIG. 11, FIG. 12, and FIG. 13, the first holding member 64 extends from the first member 61. Specifically, the first holding member 64 extends from the second portion 72 of the first member 61. The first holding member 64 extends, bending from the first member 61. The first holding member 64 extends so as to approach the second member 62 from the first member 61. For example, in the first holding member 64, an end portion coupled to the first member 61 is a base end, and an opposite end is a tip. The first holding member 64 extends such that a distance between the tip of the first holding member 64 and the second member 62 in the first direction D1 is less than a distance between the base end of the first holding member 64 and the second member 62 in the first direction D1. The distance between the base end of the first holding member 64 and the second member 62 in the first direction D1 matches the second distance A2, for example.

The first holding member 64 includes a first holding surface 82. The first holding surface 82 is a surface facing inward in the enclosing unit 47. In other words, the first holding surface 82 is a surface facing at least one of the first tip portion 32 and the second tip portion 34 enclosed by the enclosing unit 47. The first holding surface 82 is continuous with the second surface 75. An angle between the second surface 75 and the first holding surface 82 is, for example, an angle σ1.

The first holding member 64 extends away from the third member 63, for example. Therefore, when a distance between the base end of the first holding member 64 and the inner surface 81 in the third direction D3 is denoted as a first base end distance B11 and a distance between the tip of the first holding member 64 and the inner surface 81 in the third direction D3 is denoted as a first tip distance B12, the first tip distance B12 is longer than the first base end distance B11. In other words, a distance between the first holding surface 82 and the inner surface 81 increases continuously or stepwise in the first direction D1. In this case, the angle σ1 is greater than 90° and less than 180°. Thus, the first holding member 64 is inclined with respect to the inner surface 81 and extends away from the inner surface 81. The first holding member 64 may extend parallel to the third member 63. In this case, the angle σ1 is 90°.

The second holding member 65 is a member configured to hold at least one of the first tube 27 and the second tube 28 with the inner surface 81 in a state in which the first tube 27 and the second tube 28 are attached to the guide 45. The second holding member 65, similar to the first holding member 64, is a member that comes into contact with at least one of the first tube 27 and the second tube 28, thereby suppressing the falling of the first tube 27 and the second tube 28 out of the enclosing unit 47.

The second holding member 65 extends from the second member 62. Specifically, the second holding member 65 extends from the second enclosing portion 78 of the second member 62. The second holding member 65 extends, bending from the second member 62. The second holding member 65 extends so as to approach the first member 61 from the second member 62. For example, in the second holding member 65, an end portion coupled to the second member 62 is a base end, and an opposite end is a tip. The second holding member 65 extends such that a distance between the tip of the second holding member 65 and the first member 61 in the first direction D1 is less than a distance between the base end of the second holding member 65 and the first member 61 in the first direction D1. The distance between the base end of the second holding member 65 and the first member 61 in the first direction D1 matches the second distance A2, for example.

The second holding member 65 is also considered to extend so as to approach the first holding member 64. For example, the second holding member 65 extends such that a distance between the base end of the first holding member 64 and the base end of the second holding member 65 in the first direction D1 is less than a distance between the base end of the first holding member 64 and the base end of the second holding member 65 in the first direction D1. That is, it can be said that the first pressing member 64 and the second pressing member 65 extend so that, in a case in which the enclosing unit 47 is viewed in a plan view from the second direction D2, for example, one tip approaches the other tip.

The second holding member 65 includes a second holding surface 83. The second holding surface 83 is a surface facing inward in the enclosing unit 47. The second holding surface 83 is continuous with the opposing surface 79. An angle between the opposing surface 79 and the second holding surface 83 is an angle σ2. In this example, the angle σ2 is greater than the angle σ1, but may be less than or match the angle σ2.

The second holding member 65 extends away from the third member 63, for example. Therefore, when a distance between the base end of the second holding member 65 and the inner surface 81 in the third direction D3 is denoted as a second base end distance B21 and a distance between the tip of the second holding member 65 and the inner surface 81 in the third direction D3 is denoted as a second tip distance B22, the second tip distance B22 is longer than the second base end distance B21. In other words, a distance between the second holding surface 83 and the inner surface 81 increases continuously or stepwise in an opposing direction opposite to the first direction D1. In this case, the angle σ2 is greater than 90° and less than 180°. As described above, the second holding member 65 is inclined with respect to the inner surface 81 and extends away from the inner surface 81. The second holding member 65 may extend parallel to the third member 63. In this case, the angle σ2 is 90°.

The second holding member 65 may, for example, extend so as to intersect an extension line of the first holding member 64 when the enclosing unit 47 is viewed in plan view from the second direction D2. The second holding member 65 may, for example, extend so that an extension line of the second holding member 65 intersects the first holding member 64 when the enclosing unit 47 is viewed in plan view from the second direction D2. The second holding member 65 may, for example, extend so that the extension line of the second holding member 65 intersects the extension line of the first holding member 64 when the enclosing unit 47 is viewed in plan view from the second direction D2. In such a case, the second holding member 65 extends away from the inner surface 81.

The second holding member 65 is offset with respect to the first holding member 64 in the second direction D2. The second direction D2 is a direction different from the first direction D1 and the third direction D3. The second direction D2 is the direction in which the first tube 27 and the second tube 28 enclosed by the enclosing unit 47 extend. The second direction D2 is, for example, the direction when the guide 45 is viewed in plan view, and is the direction when the enclosing unit 47 is viewed in plan view. The second direction D2 can also be referred to as a direction intersecting the first direction D1, and can also be referred to as a direction intersecting the third direction D3.

The second holding member 65 is positioned between the attachment unit 46 and the first holding member 64 in the second direction D2, for example. Therefore, the second holding member 65 holds a portion of the first tip portion 32 and the second tip portion 34 closer to the base end than a portion held by the first holding member 64. Thus, the first holding member 64 and the second holding member 65 are disposed offset from each other in a staggered manner. The second holding member 65 may hold a portion of the first tip portion 32 and the second tip portion 34 closer to the tip than a portion held by the first holding member 64.

The first holding member 64 and the second holding member 65 are offset from each other in a staggered manner, and thus the first tube 27 and the second tube 28 are bent so as to avoid the first holding member 64 and the second holding member 65, making it possible to pass the first tube 27 and the second tube 28 between the first holding member 64 and the second holding member 65. That is, the first tube 27 and the second tube 28 can be attached to the enclosing unit 47 in the direction opposite to the third direction D3. As a result, the first tube 27 and the second tube 28 are enclosed by the enclosing unit 47.

The first tube 27 and the second tube 28, after being attached to the enclosing unit 47, each return from a posture of bending to a posture of extending along the first member 61 and the second member 62 by elasticity. As a result, at least one of the first tube 27 and the second tube 28 enclosed by the enclosing unit 47 is held by the first holding member 64 and the second holding member 65. This prevents the first tube 27 and the second tube 28 from falling out.

The enclosing unit 47 includes an enclosed region 85 through which the first tip portion 32 and the second tip portion 34 pass. The enclosed region 85 is, for example, a region enclosed by the first member 61, the second member 62, the third member 63, the first holding member 64, and the second holding member 65 when the enclosing unit 47 is viewed in plan view. The enclosed region 85 is the region indicated by shading in FIG. 12. The enclosing unit 47 encloses the first tip portion 32 and the second tip portion 34 that pass through the enclosed region 85.

An interval between the first holding member 64 and the second holding member 65 in the first direction D1 is a first interval C1. The first interval C1 is smaller than the first diameter R1 and the second diameter R2, for example. Thus, the first tube 27 and the second tube 28 extending in the second direction D2 cannot pass through the gap between the first holding member 64 and the second holding member 65. The first tube 27 and the second tube 28 attached to the enclosing unit 47, that is, passing through the enclosed region 85, are in postures extending in the second direction D2, and thus do not fall out of the enclosing unit 47.

An interval between the first holding member 64 and the second holding member 65 in the second direction D2 is a second interval C2. The second interval C2 is larger than the first diameter R1 and the second diameter R2, for example. Therefore, the first tube 27 and the second tube 28 are bent, extending in the first direction D1, and thus can pass through the gap between the first holding member 64 and the second holding member 65. That is, the first tube 27 and the second tube 28 can be attached to the enclosing unit 47 by bending the first tube 27 and the second tube 28 so as to avoid the first holding member 64 and the second holding member 65. Thus, the first tube 27 and the second tube 28 can be attached to the enclosing unit 47 without being inserted into the enclosed region 85 in the second direction D2.

The first interval C1 being smaller than the first diameter R1 and the second diameter R2 and the second interval C2 being larger than the first diameter R1 and the second diameter R2 is an example of a condition that facilitates the passing, through the gap between the first holding member 64 and the second holding member 65, and the attachment to the enclosing unit 47 of the first tube 27 and the second tube 28 while facilitating the holding of the first tube 27 and the second tube 28 by the first holding member 64 and the second holding member 65. Actually, the condition is determined by a three-dimensional distance between the first holding member 64 and the second holding member 65.

As illustrated in FIG. 6, when the guide 45 is viewed in plan view, a portion of the enclosing unit 47 is exposed through the first passage opening 55 and the second passage opening 59. Specifically, for example, when the first passage opening 55 is viewed in plan view, the first member 61 or the first holding member 64 is exposed through the first passage opening 55. In this example, the first member 61 and the third member 63 are exposed through the first passage opening 55. For example, the second member 62 or the second holding member 65 is exposed through the second passage opening 59. In this example, the second member 62 and the second holding member 65 are exposed through the second passage opening 59. In this way, the enclosing unit 47 is positioned relative to the first clamp 51 and the second clamp 52, exposing a portion of the enclosing unit 47 through the first passage opening 55 and the second passage opening 59. Expressed in another way, the first clamp 51 and the second clamp 52 are positioned relative to the enclosing unit 47, exposing the first member 61 or the first holding member 64 through the first passage opening 55 and exposing the second member 62 or the second holding member 65 through the second passage opening 59.

With the above-described positional relationship, the interval between the portions of the first tip portion 32 and the second tip portion 34 enclosed by the enclosing unit 47 is smaller than the interval between the portion enclosed by the first clamp 51 and the portion enclosed by the second clamp 52. Specifically, the portion of the first tip portion 32 enclosed by the enclosing unit 47 and the portion of the second tip portion 34 enclosed by the enclosing unit 47 may come into contact with each other. In contrast, the portion of the first tip portion 32 enclosed by the first clamp 51 and the portion of the second tip portion 34 enclosed by the second clamp 52 do not come into contact with each other. Accordingly, the first tip portion 32 and the second tip portion 34 are bundled, decreasing the interval between the two from upstream to downstream. The first tip portion 32 and the second tip portion 34 are aggregated toward the opening portion 38.

Next, an example of the attachment procedure of the first tube 27 and the second tube 28 to the enclosing unit 47 will be described.

First, the first tube 27 is attached to the enclosing unit 47. At this time, the first tube 27 may be attached to the enclosing unit 47 by the first tip portion 32 being inserted into the enclosed region 85, or may be attached to the enclosing unit 47 by the first tip portion 32 being passed through the gap between the first holding member 64 and the second holding member 65. That is, the first tube 27 may be moved in the second direction D2 to attach the first tube 27 to the enclosing unit 47, or the first tube 27 may be moved in the direction opposite to the third direction D3 to attach the first tube 27 to the enclosing unit 47. In a case in which the first tip portion 32 is inserted into the enclosed region 85 while moving the first tube 27 in the second direction D2, the tip may come into contact with the third surface 76. In this case, the first tip portion 32 is guided along the third surface 76 toward the second portion 72. As a result, the first tip portion 32 can be smoothly inserted.

Next, the second tube 28 is attached to the enclosing unit 47. At this time, the second tube 28 is attached to the enclosing unit 47 by passing the second tip portion 34 through the gap between the first holding member 64 and the second holding member 65. That is, the second tube 28 is moved in a direction opposite to the third direction D3 to attach the first tube 27 to the enclosing unit 47. When the second tube 28 is attached to the enclosing unit 47 by the second tip portion 34 being inserted into the enclosed region 85 while moving in the second direction D2, the second tube 28 rubs against the previously attached first tube 27. In this case, the first tube 27 or the second tube 28 may be damaged. Therefore, the second tip portion 34 is attached to the enclosing unit 47 through the gap between the first holding member 64 and the second holding member 65. In this way, the rubbing between the first tube 27 and the second tube 28 can be suppressed. That is, the structure can be such that the first tube 27 is inserted into the enclosed region 85 in the second direction or the direction opposite to the second direction D2, while the second tube 28 is inserted into the enclosed region 85 in the direction opposite to the third direction D3. As a result, the degree to which the second tube 28 rubs against the first tube 27 can be reduced compared to a case in which the second tube 28 is inserted in a longitudinal direction of the first tube 27 previously attached to the guide 45.

The attachment of the first tube 27 to the first clamp 51 and the attachment of the second tube 28 to the second clamp 52 may be before or after attachment to the enclosing unit 47.

Next, the functions and effects of the exemplary embodiment described above will be described.

(1) The first holding member 64 and the second holding member 65 are disposed offset from each other in a staggered manner. According to the configuration described above, the first tube 27 and the second tube 28 are bent so as to avoid the first holding member 64 and the second holding member 65, making it possible to pass the first tube 27 and the second tube 28 through the gap between the first holding member 64 and the second holding member 65. As a result, the first tube 27 and the second tube 28 are enclosed by the enclosing unit 47 and attached to the guide 45. When the first tube 27 and the second tube 28 are attached to the guide 45 in this manner, friction between the first tube 27 and the second tube 28 is reduced compared to a case in which the first tube 27 and the second tube 28 are attached to the guide 45 by inserting the first tube 27 and the second tube 28 into the enclosing unit 47. Accordingly, damage to the first tube 27 and the second tube 28 can be suppressed.

(2) The first holding member 64 and the second holding member 65 are inclined with respect to the inner surface 81 and extend away from the inner surface 81.

According to the configuration described above, a space in which the enclosing unit 47 encloses the first tube 27 and the second tube 28 is wide compared to a case in which, for example, the first holding member 64 and the second holding member 65 inclined with respect to the inner surface 81 extend so as to approach the inner surface 81. For example, the enclosed region 85 is larger. As a result, the first tube 27 and the second tube 28 are easily attached to the guide 45.

(3) The first clamp 51 and the second clamp 52 are positioned relative to the enclosing unit 47, exposing the first member 61 or the first holding member 64 through the first passage opening 55 and exposing the second member 62 or the second holding member 65 through the second passage opening 59.

According to the configuration described above, in the first tube 27 and the second tube 28, the interval between the portions enclosed by the enclosing unit 47 is smaller than the interval between the portions held by the first clamp 51 and the second clamp 52. That is, the first tube 27 and the second tube 28 are aggregated from the first clamp 51 and the second clamp 52 toward the enclosing unit 47. As a result, the first tube 27 and the second tube 28 are easily inserted into the opening portion 38.

(4) The first member 61 includes the first portion 71 having a distance to the second member 62 denoted as the first distance A1, the second portion 72 having a distance to the second member 62 denoted as the second distance A2, the second distance A2 being less than the first distance A1, and the third portion 73 coupled to the first portion 71 and the second portion 72 and inclined with respect to the first portion 71 and the second portion 72. The second portion 72 faces portions of the first tube 27 and the second tube 28 closer to the tips than portions faced by the first portion 71. In other words, The second portion 72 faces portions of the first tube 27 and the second tube 28 closer to the tips than portions facing the first portion 71.

In a case in which the tubes are attached one by one, the first tube may be attached to the guide 45 by being inserted into the enclosing unit 47. In this case, the tip of the first tube comes into contact with the third portion 73, which is inclined, making smooth insertion into the enclosing unit 47 possible. Accordingly, according to the configuration described above, the first tube is easily attached.

(5) The first interval C1 is smaller than the first diameter R1 and the second diameter R2, and the second interval C2 is larger than the first diameter R1 and the second diameter R2.

According to the configuration described above, the first tube 27 and the second tube 28 are bent so as to avoid the first holding member 64 and the second holding member 65, making it possible to pass the first tube 27 and the second tube 28 through the gap between the first holding member 64 and the second holding member 65. The first tube 27 and the second tube 28 enclosed by the enclosing unit 47 are held by the first holding member 64 and the second holding member 65 by being in postures extending in the second direction D2. In this way, the possibility of the first tube 27 and the second tube 28 falling out of the enclosing unit 47 can be reduced.

This exemplary embodiment described above may be modified as follows. This exemplary embodiment and modified examples thereof to be described below may be implemented in combination within a range in which a technical contradiction does not arise.
The first holding member 64 may extend so as to approach the third member 63. In this case, the first base end distance B11 is longer than the first tip distance B12. The angle σ1 is less than 90°.
The second holding member 65 may extend so as to approach the third member 63. In this case, the second base end distance B21 is longer than the second tip distance B22. The angle σ2 is less than 90°.
The first member 61 and the second member 62 need not be coupled by the third member 63. That is, the enclosing unit 47 need not include the third member 63. For example, instead of the third member 63, a member may be provided that includes a gap to the extent that the first tube 27 and the second tube 28 cannot pass therethrough. Instead of the third member 63, the first holding member 64 and the second holding member 65 may be further provided.
The liquid ejected by the ejecting unit 15 is not limited to ink, and may be, for example, a liquid body including particles of a functional material dispersed or mixed in liquid. For example, the ejecting unit 15 may eject a liquid body including a material such as an electrode material or a pixel material used in manufacture of a liquid crystal display, an electroluminescent display, and a surface emitting display in a dispersed or dissolved form.

Hereinafter, technical concepts and effects thereof that are understood from the above-described exemplary embodiments and modified examples will be described.

(A) A liquid ejecting device includes an ejecting unit configured to eject a liquid onto a medium, at least one accommodating unit configured to receive the liquid ejected from the ejecting unit as a waste liquid, a first tube including a first tip portion that is a portion including a tip and configured to pass the waste liquid received by the accommodating unit, a second tube including a second tip portion that is a portion including a tip and configured to pass the waste liquid received by the accommodating unit, a storage unit including an opening portion through which the first tip portion and the second tip portion are inserted, and configured to store the waste liquid, and a guide to which the first tube and the second tube are attached, and configured to guide the first tip portion and the second tip portion to the opening portion. The guide includes an enclosing unit configured to enclose the first tip portion and the second tip portion. The enclosing unit includes a first member and a second member that face each other and sandwich the first tip portion and the second tip portion, a first holding member extending from the first member so as to approach the second member, and a second holding member extending from the second member so as to approach the first member. The first holding member and the second holding member are disposed offset from each other in a staggered manner.

According to the configuration described above, the first tube and the second tube are bent so as to avoid the first holding member and the second holding member, making it possible to pass the first tube and the second tube through a gap between the first holding member and the second holding member. As a result, the first tube and the second tube are enclosed by the enclosing unit and attached to the guide. When the first tube and the second tube are attached to the guide in this manner, friction between the first tube and the second tube is reduced compared to a case in which the first tube and the second tube are attached to the guide by inserting the first tube and the second tube into the enclosing unit. Accordingly, damage to the first tube and the second tube can be suppressed.

(B) In the liquid ejecting device described above, the liquid ejecting device includes a third member coupled to the first member and the second member. The third member includes an inner surface facing inward in the enclosing unit, and the first holding member and the second holding member are inclined with respect to the inner surface and extend away from the inner surface.

According to the configuration described above, a space in which the enclosing unit encloses the first tube and the second tube is wide compared to a case in which, for example, the first holding member and the second holding member inclined with respect to the inner surface extend so as to approach the inner surface. As a result, the first tube and the second tube are easily attached to the guide.

(C) In the liquid ejecting device described above, the first tube includes a first base end portion that is a portion including a base end, the second tube includes a second base end portion that is a portion including a base end, the guide includes a first clamp configured to enclose a portion of the first tube closer to the base end than a portion enclosed by the enclosing unit, thereby holding the first tube, and a second clamp configured to enclose a portion of the second tube closer to the end portion than a portion enclosed by the enclosing unit, thereby holding the second tube, the first clamp includes a first passage opening through which the first tube passes, the second clamp includes a second passage opening through which the second tube passes, and the first clamp and the second clamp are positioned, with respect to the enclosing unit, so that the first member or the first holding member is exposed through the first passage opening, and the second member or the second holding member is exposed through the second passage opening.

According to the configuration described above, in the first tube and the second tube, an interval between the portions enclosed by the enclosing unit is smaller than an interval between the portions held by the first clamp and the second clamp. That is, the first tube and the second tube are aggregated from the first clamp and the second clamp toward the enclosing unit. As a result, the first tube and the second tube are easily inserted into the opening portion.

(D) In the liquid ejecting device described above, the first member includes a first portion having a distance to the second member denoted as a first distance, a second portion having a distance to the second member denoted as a second distance, the second distance being less than the first distance, and a third portion coupled to the first portion and the second portion and inclined with respect to the first portion and the second portion. The second portion faces portions of the first tube and the second tube closer to the tips than portions facing the first portion.

In a case in which the tubes are attached one by one, the first tube may be attached to the guide by being inserted into the enclosing unit. In this case, the tip of the first tube comes into contact with the third portion, which is inclined, making smooth insertion into the enclosing unit possible. Accordingly, according to the configuration described above, the first tube is easily attached.

(E) In the liquid ejecting device described above, an interval between the first holding member and the second holding member in a first direction in which the first member and the second member face each other is less than a diameter of the first tube and a diameter of the second tube, and an interval between the first holding member and the second holding member in a second direction intersecting the first direction is greater than the diameter of the first tube and the diameter of the second tube.

According to the configuration described above, the first tube and the second tube are bent so as to avoid the first holding member and the second holding member, making it possible to pass the first tube and the second tube through the gap between the first holding member and the second holding member. The first tube and the second tube enclosed by the enclosing unit are held by the first holding member and the second holding member by being in postures extending in the second direction. In this way, the possibility of the first tube and the second tube falling out of the enclosing unit can be reduced.

What is claimed is:

1. A liquid ejecting device comprising:
an ejecting unit configured to eject a liquid onto a medium;
at least one accommodating unit configured to receive the liquid ejected from the ejecting unit as a waste liquid;
a first tube including a first tip portion that is a portion including a tip and configured to pass the waste liquid received by the accommodating unit;
a second tube including a second tip portion that is a portion including a tip and configured to pass the waste liquid received by the accommodating unit;
a storage unit including an opening portion through which the first tip portion and the second tip portion are inserted, and configured to store the waste liquid; and
a guide to which the first tube and the second tube are attached, and configured to guide the first tip portion and the second tip portion to the opening portion, wherein
the guide includes an enclosing unit configured to enclose the first tip portion and the second tip portion,
the enclosing unit includes
a first member and a second member that face each other and sandwich the first tip portion and the second tip portion,
a first holding member extending from the first member so as to approach the second member, and
a second holding member extending from the second member so as to approach the first member, and
the first holding member and the second holding member are disposed offset from each other in a staggered manner.

2. The liquid ejecting device according to claim 1, comprising:
a third member coupled to the first member and the second member, wherein
the third member includes an inner surface facing inward in the enclosing unit and
the first holding member and the second holding member are inclined with respect to the inner surface and extend away from the inner surface.

3. The liquid ejecting device according to claim 1, wherein
the first tube includes a first base end portion that is a portion including a base end,
the second tube includes a second base end portion that is a portion including a base end,
the guide includes
a first clamp configured to enclose a portion of the first tube closer to the base end than a portion enclosed by the enclosing unit, thereby holding the first tube and
a second clamp configured to enclose a portion of the second tube closer to the end portion than a portion enclosed by the enclosing unit, thereby holding the second tube,
the first clamp includes a first passage opening through which the first tube passes,
the second clamp includes a second passage opening through which the second tube passes, and
the first clamp and the second clamp are positioned, with respect to the enclosing unit, so that the first member or the first holding member is exposed through the first passage opening, and the second member or the second holding member is exposed through the second passage opening.

4. The liquid ejecting device according to claim 1, wherein
the first member includes
a first portion having a distance to the second member denoted as a first distance,
a second portion having a distance to the second member denoted as a second distance, the second distance being less than the first distance, and
a third portion coupled to the first portion and the second portion and inclined with respect to the first portion and the second portion, and
the second portion faces portions of the first tube and the second tube closer to the tips than portions facing the first portion.

5. The liquid ejecting device according to claim 1, wherein
an interval between the first holding member and the second holding member in a first direction in which the first member and the second member face each other is less than a diameter of the first tube and a diameter of the second tube and
an interval between the first holding member and the second holding member in a second direction intersecting the first direction is greater than the diameter of the first tube and the diameter of the second tube.
